(19) United States
(12) Patent Application Publication
(10) Pub. No.: US 2025/0035170 A1
(43) Pub. Date: Jan. 30, 2025

(54) ACTUATION SYSTEM FOR A MOTOR

(71) Applicant: Dana Motion Systems Italia S.R.L., Reggio Emilia (IT)

(72) Inventors: Luca FONTANESI, Reggio Emilia (IT); Fabio NATALI, Modena (IT); Paolo COMODI, Reggio Emilia (IT)

(21) Appl. No.: 18/357,586

(22) Filed: Jul. 24, 2023

(51) Int. Cl. F15B 15/26; F03C 1/00; F03C 1/02; F15B 15/14; F16D 49/16; F16D 65/06; F16D 65/18

(52) U.S. Cl. CPC F16D 49/16; F03C 1/002; F03C 1/02; F03C 1/0636; F16D 65/06; F16D 65/18; F15B 15/1404; F15B 15/262; F16D 2121/04; F16D 2121/14

(57) ABSTRACT

Methods and systems for a hydraulic axial piston motor with a braking system are described. A brake assembly for a hydraulic axial piston motor, comprising: a cylinder block and a pair of braking pads positioned around the cylinder block, wherein compression of the braking pads against an outer surface of the cylinder block realizes braking of the cylinder block.

### TECHNICAL FIELD

The present disclosure relates generally to hydraulic motors, and more specifically to a brake assembly for a hydraulic motor and a method of operating the brake assembly.

### BACKGROUND AND SUMMARY

A hydraulic axial piston motor may include a bent axis or swash plate motor unit. Likewise, a hydraulic axial piston motor may be a fixed or a variable displacement motor. Such motors may be used as a part of a machine, such as part of an on-highway or off-highway vehicle, or as part of a stationary system for driving an implement. These units may include a fixed or variable displacement. For an example, a family of motors, referred to herein as a H4VA family of motors, may be swashplate motors. A hydraulic axial piston motor, such as a motor of the H4VA family of motors, may use a brake comprising a plurality of brake disks to provide friction for braking. The brake disks may be kept in place and engaged via at least a piston and a plurality of springs. When braking, hydraulic fluid may be used to actuate the piston or pistons toward the brake disks. After advancing a distance, the piston or pistons may press upon and apply a force on the brake disks. The force provided by the piston or pistons may cause friction between the brake disks of the brake. The friction may produce a braking torque. The braking torque may act against the torque of the hydraulic motor received by a shaft of the hydraulic axial piston motor. The braking torque may slow and/or stop the rotation of the shaft for the hydraulic axial piston motor.

When braking the brake, the braking torque may fluctuate in the braking phase. Such fluctuations may cause the components of the hydraulic axial piston motor to vibrate. Over time such vibrations may cause degradation. Additionally, a larger application of motor torque received by the shaft and a braking torque, may cause vibrations of greater energy that may cause more acute forms of degradation. Likewise, such vibrations may cause components of the hydraulic axial piston motor to become misaligned, such that they may be not drivingly coupled or drivingly coupled but not approximately parallel with a longitudinal axis. Additionally, the fluctuations in torque may cause a vehicle, implement, or another component driven by the hydraulic motor to become less controllable. When uncontrolled, a component driven by the hydraulic motor may cause unintentional degradation to an object being acted on by the driven component.

The inventors herein have recognized these and other issues with such systems. In one example, at least a portion of the above mentioned issues may be addressed by a brake assembly for a hydraulic axial piston motor, comprising: a cylinder block and a pair of braking pads positioned around the cylinder block, wherein compression of the braking pads against an outer surface of the cylinder block realizes braking of the cylinder block. In this way, the brake torque may be applied at more constant amount to a cylinder block by the drum configuration brake pads compared to brake disks. A more constant brake torque may reduce vibrations and non-rotational movement of cylinder block, complementary and drivingly coupled shaft, and complementary implement.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various Aspects of this Disclosure May be Better Understood Upon Reading the Following Detailed Description and Upon Reference to the Drawings, in which:

FIG. 1 is a schematic representation of a motor system, in accordance with one or more embodiments of the present disclosure;

FIG. 2 is a first cross section view of a motor assembly including the components of a motor block housing, a hydraulic block housing, a rotary group, and a plier assembly;

FIG. 3A is a second cross section of the motor assembly including a brake assembly positioned between the and about the components of FIG. 2;

FIG. 3B is the second cross section of FIG. 3A with additional components;

FIG. 4 is a third cross section of the motor block housing showing the components of the plier assembly;

FIG. 5 is a fourth cross section of the motor block housing showing an area about a portion of the brake assembly;

FIG. 6 shows a side view of a cylinder block isolated from the other components of the motor block housing;

FIG. 7 shows a side view of the plier assembly isolated from other components of the motor block housing;

FIG. 8A shows a fifth cross section of the area of FIG. 5 when the brake assembly is engaged in a first position;

FIG. 8B shows the fifth cross section of the area of FIG. 5 when the brake assembly is engaged in a second position; and

FIG. 9 shows timing diagrams of the brake state and the braking torque.

### DETAILED DESCRIPTION

Systems and methods are provided for a hydraulic motor assembly. The hydraulic motor assembly of the present disclosure is an axial piston motor, such as an H4VA motor. A brake assembly is provided for the hydraulic motor assembly. The brake assembly applies a drum brake setup to stop the rotation of the rotational elements of the hydraulic motor assembly, such as an output or a shaft. For example, the brake assembly may be a parking brake. The braking components of the brake assembly may be engaged or disengaged via an actuation system. The actuation system may be actuated hydraulically via work fluid, such as an oil. Work fluid to the components of the brake assembly and other components of the hydraulic motor assembly may be supplied via a hydraulic block housing. The hydraulic block housing may be fastened to and fluidically coupled to a motor block housing. The passages of the hydraulic block housing may be fluidically coupled to the motor block housing via a valve plate. The valve plate may be sandwiched between features of the motor block housing and the hydraulic block housing. The valve plate may be sandwiched between components housed by the motor block housing, such as a rotary group assembly, and the features of the hydraulic housing. The motor block housing may house and support a plurality of components of the rotary group assembly and the brake assembly. However, it is to be appreciated that the hydraulic motor of the present disclosure may be non-limiting, and may be a variable balancing axial or bent axis piston motor, including a valve plate with one or more cutouts and/or grooves that facilitate the use of the brake assembly described herein in combination with operation of the brake assembly.

The brake assembly may include a plurality of actuators housed in passages of the motor block housing. Each actuator may have a complementary spring. Change in pressure of the work fluid may actuate the actuators. For example, the pressure of work fluid to the drum brake assembly may increase above a threshold of pressure that may be referred to herein as a release pressure. When the pressure of work fluid in the drum brake assembly is at or greater than the release pressure, the actuator may actuate radially, with respect to a longitudinal axis of the hydraulic motor assembly, away from a plier assembly of the drum brake assembly. When pressure is decreased below the release pressure in the drum brake assembly, the actuators may actuate radially closer toward the plier assembly.

The plier assembly may be positioned and curve about a cylinder block of the rotary group assembly. The plier assembly may comprise a pair of braking pads or braking shoes, wherein each brake pad may curve about a portion of the cylinder block. The cylinder block may be positioned about and drivingly coupled to a shaft of the rotary group assembly, such that the cylinder block may rotate or spin with the rotation or spin of the shaft. Each of the inner surfaces of a plurality of pliers of the plier assembly may be of a high frictional coefficient. Likewise, an outer surface of the cylinder block may be of a high frictional coefficient. The braking pads may comprise the inner surfaces of the pliers with a high frictional coefficient. When actuated a distance, the actuators may press and apply a force to the plier assembly. The force of the actuators may cause the inner surfaces with a high frictional coefficient of the pliers to press against the outer surface with a high frictional coefficient of the cylinder block. The friction between the inner surfaces and outer surface may generate a brake torque. The brake torque may reduce the speed of rotation of the cylinder block and shaft about the longitudinal axis. Likewise, if a frictional force from the inner surface and the outer surface is equal to or above a threshold of force is applied for a duration of time equal to or above a threshold of time, the brake torque may stop the rotation of the cylinder block and shaft about the longitudinal axis. The slowing of the rotational speed of the cylinder block and shaft may slow the rotation of the other components of the rotary group assembly. Likewise, the stopping of the rotation of the cylinder block and shaft may stop the rotation of the other components of the rotary group assembly.

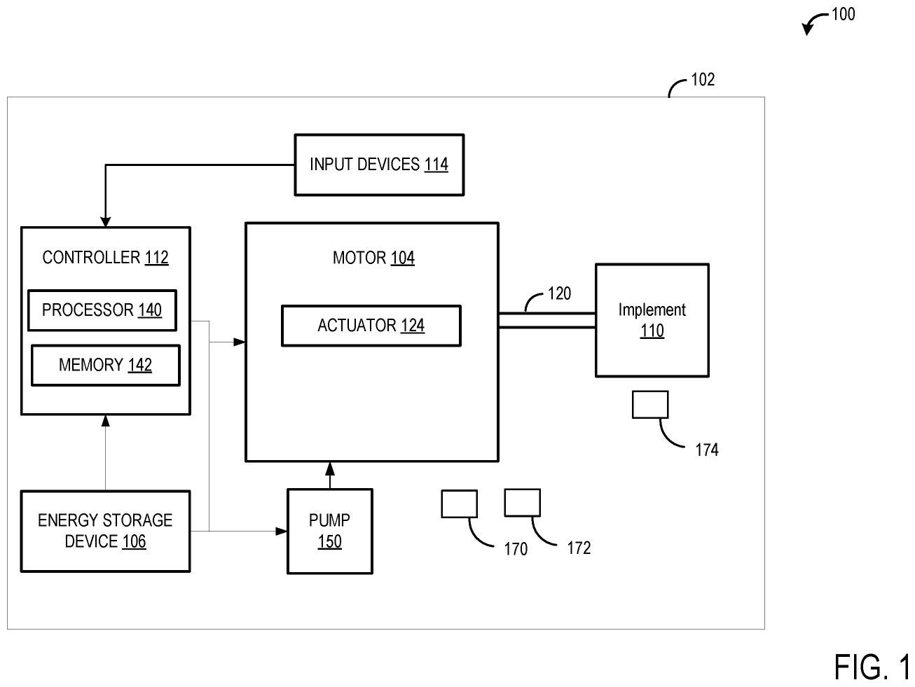

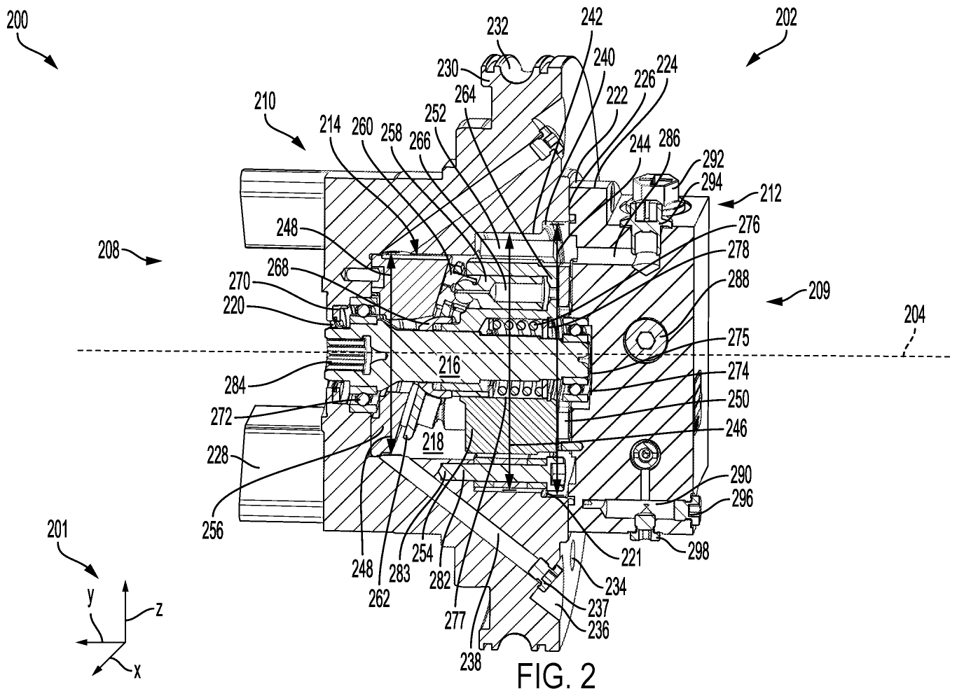

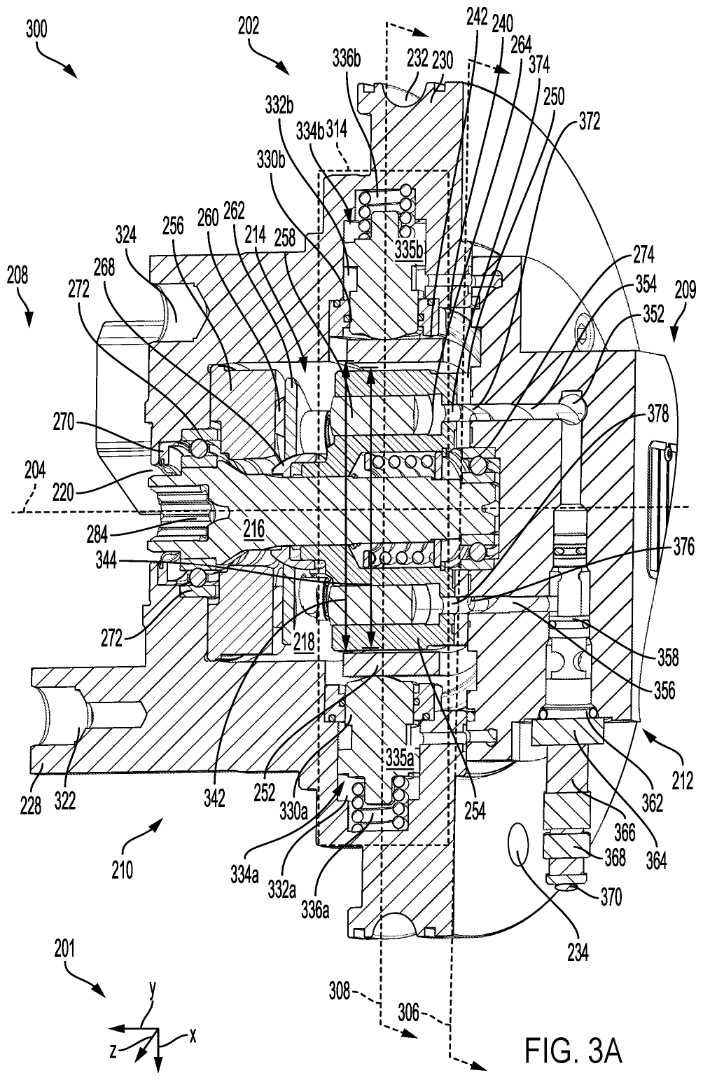

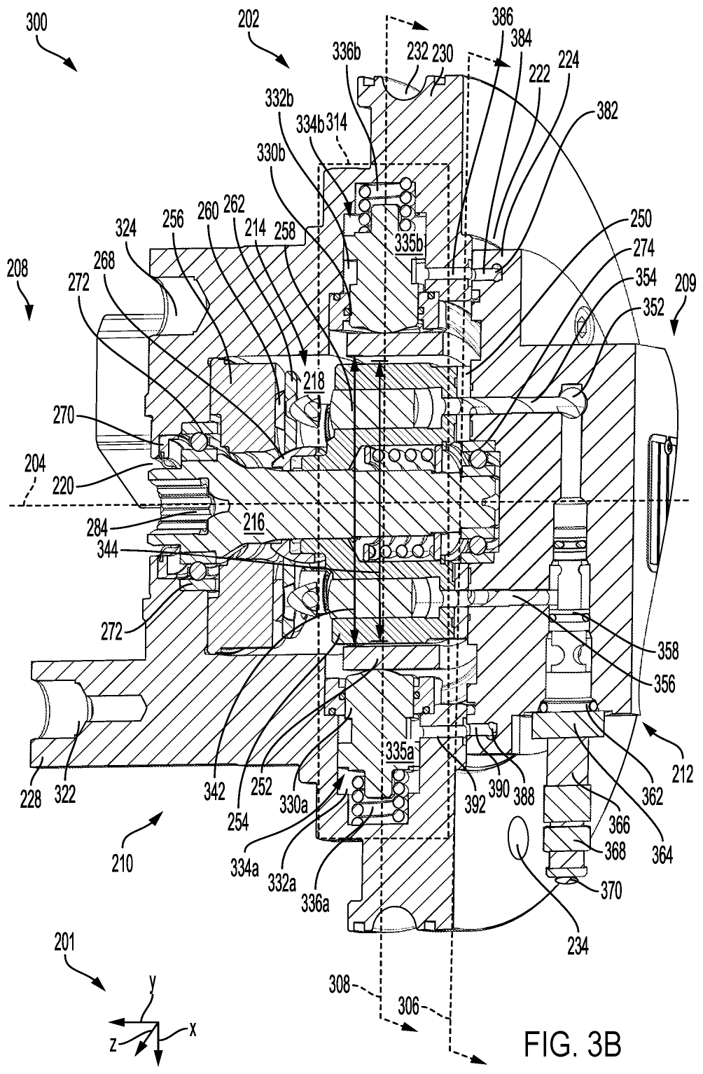

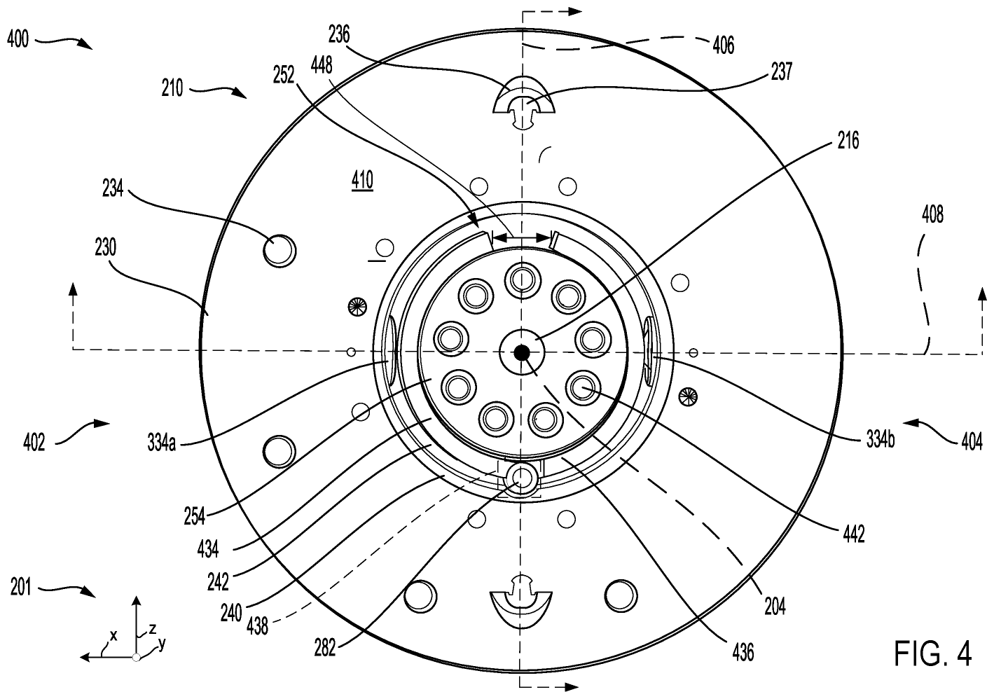

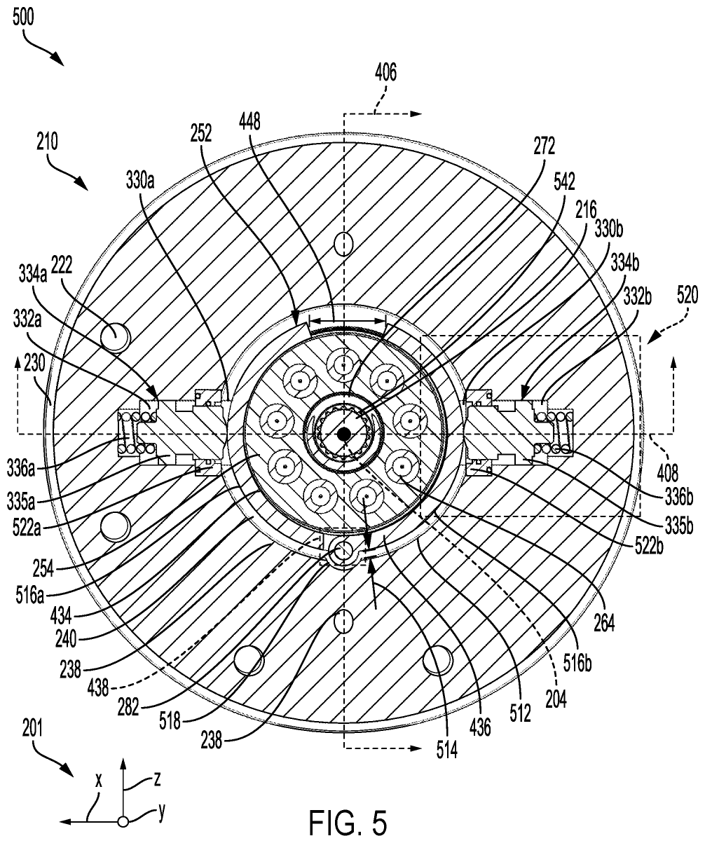

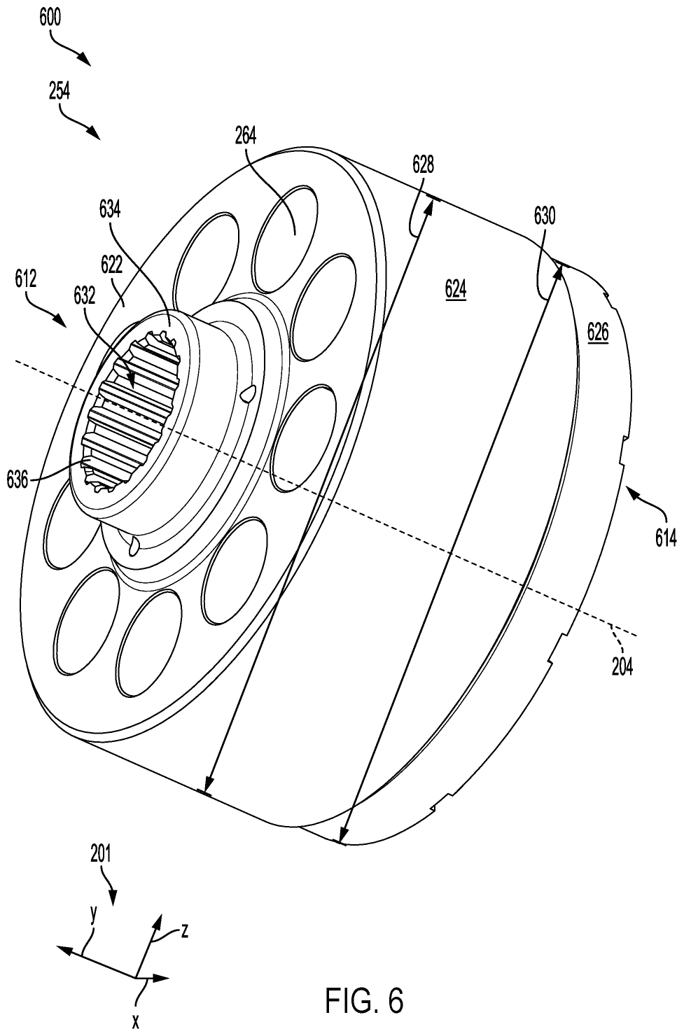

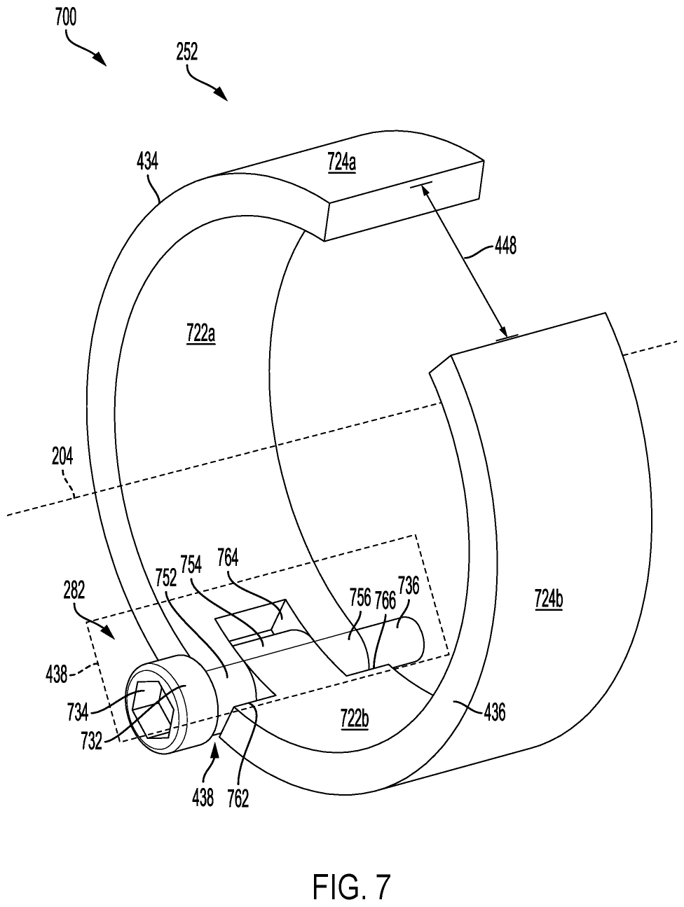

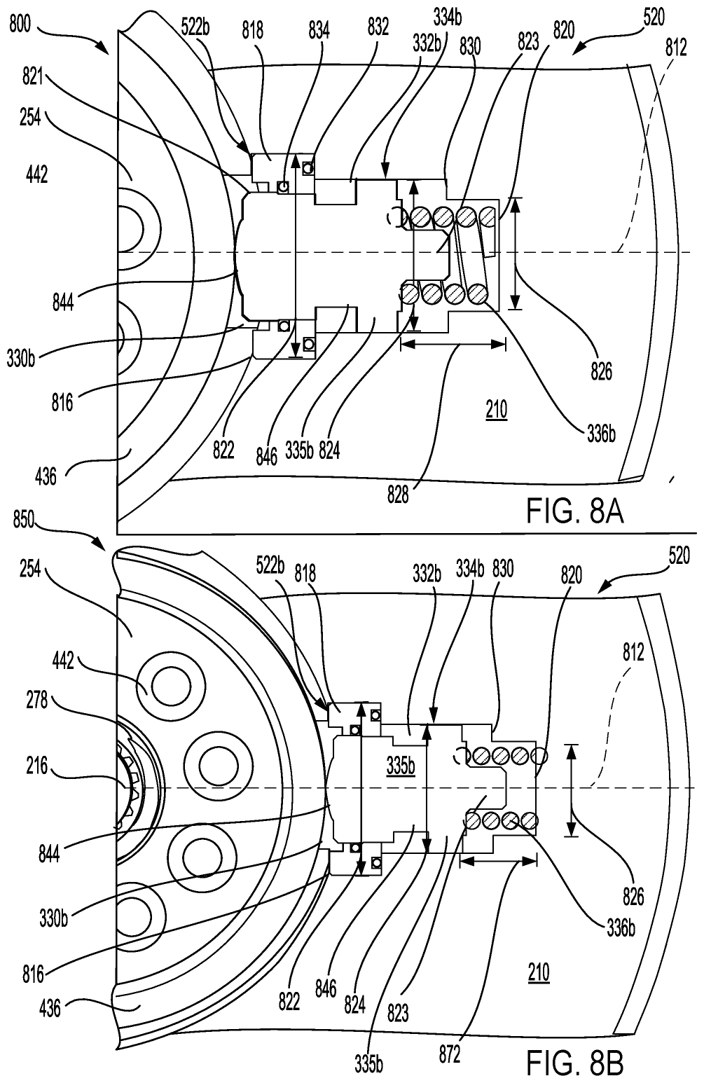

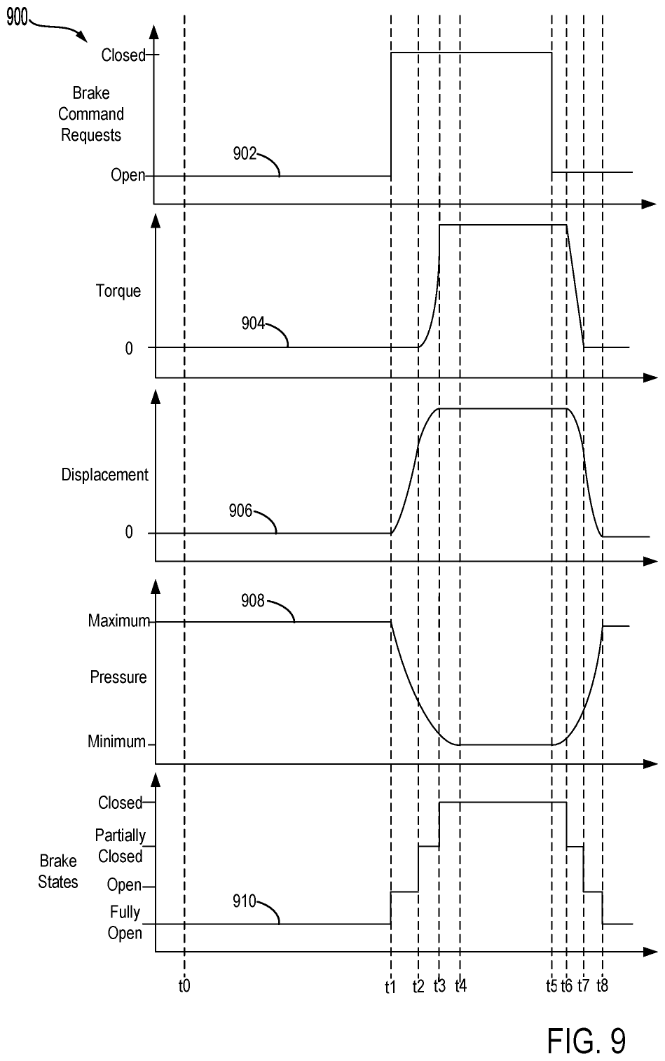

FIG. 1 is a schematic representation of a motor system. For the example shown in FIG. 1, the motor system may be used in an application to drive an implement positioned in a vehicle. However, it is to be appreciated that the motor system may be used to drive other machinery. The motor of the motor system may be a hydraulic motor of the present disclosure. FIG. 2 shows a first sectional view of a motor assembly including the components of a motor block housing, a hydraulic block housing, a rotary group, and a plier assembly. FIGS. 3A-3B show a second cross section of the motor assembly including an actuation system of the brake assembly of FIG. 2. FIG. 3A and FIG. 3B each show different labeled features such as passages and channels from the same sectional view. The sectional view of FIG. 2 and sectional view of FIG. 3A-3B may be longitudinal views. FIG. 4 is a third sectional view of the motor block housing showing components of the plier assembly. FIG. 5 is a fourth sectional view showing the components of the brake assembly positioned about the plier assembly of FIG. 4. FIG. 5 shows an area about components of the brake assembly. FIG. 6 shows a side view of a cylinder block isolated from the other components of the motor block housing. FIG. 7 shows a side view of the plier assembly isolated from other components of the motor block housing. FIG. 6 shows the outer surface of a cylinder block and FIG. 7 shows the inner surfaces of the plier assembly that may be used to generate friction and a braking torque for a shaft and plurality of other components of the rotary group. FIG. 8A shows a fifth cross section of the area of FIG. 5 when the brake assembly is engaged in a first position. FIG. 8B shows the fifth cross section of the area of FIG. 5 when the brake assembly is engaged in a second position. The first position may be a position to engage the brake and the second position may be a position to disengage the brake. FIG. 9 shows a plurality of timing diagrams of the brake state and the braking torque.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 1 show schematics of example configurations with relative positioning of the various components. Herein, when the motor system and/or housing of the motor system is positioned on level ground, vertical is shown with respect to gravity. FIGS. 2-8B are shown approximately to scale, although other relative dimensions may be used. As used herein, the terms “approximately” is construed to mean plus or minus five percent of the range unless otherwise specified.

Further, FIGS. 1-8B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of the element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Referring now to FIG. 1, a schematic depiction of a motor system 100 of a vehicle 102 is shown, including a motor 104 coupled to a controller 112, and to one or more of an implement 110 of the vehicle via a drive shaft 120. It should be appreciated that while FIG. 1 refers to an embodiment within a vehicle, in other embodiments the motor system 100 may be included in a different machine that generates torque for another purpose. Likewise, in other embodiments the motor 104 may supply rotational energy via torque to another component than the drive shaft 120 or the implement 110. For example, the motor 104 may supply torque directly to an implement that may act upon an object instead of via a shaft, such as drive shaft 120. For another example, the motor 104 may supply torque to an input, such as a shaft, gear, or another rotational element, to a reduction assembly or another set of rotational elements, such as a gear set. The motor may be an axial motor, bent axis motor, or other motor. In one example, the motor is a hydraulic fluid displacement motor.

It is to be appreciated that the housing and system that uses the motor system 100 is non-limiting. For example, the motor system 100 may not be housed in a vehicle, such as vehicle 102, and may instead be housed in a housing that may not be self-propelled, such as a trailer-carried housing or a stationary housing.

As the cylinder block rotates, an amount of torque is generated on drive shaft 120 by pressurized hydraulic fluid pumped into motor 104 by a pump 150. The pump 150 may be part of a hydraulic circuit comprising a regulator and valves for controlling the flow of hydraulic fluid. To increase or decrease the amount of torque, a pressure on a side of a valve plate of the rotary group with respect to drive shaft 120 may be adjusted. By adjusting the pressure, a displacement of the rotary group may be increased, causing the amount of torque to increase, or the displacement of the rotary group may be decreased, causing the amount of torque to decrease.

Motor 104 may be indirectly powered by an energy storage device 106 via the pump 150. Specifically, energy stored in energy storage device 106 may be used to power the pump 150 that may power an actuator 124 of motor 104, where actuator 124 adjusts balancing of a valve plate to vary the amount of torque delivered at drive shaft 120. In one example, the actuator 124 is an actuator of a valve. Energy storage device 106 may be an energy storage device configured to deliver electrical power to various components of an electrical system of the vehicle 102 including supplying current to motor 104. Energy storage device 106 may be electrically coupled to motor 104, pump 150, and/or controller 112. Controller 112 may regulate the power supply provided by energy storage device 106 to motor 104 in order to increase or decrease a speed of the vehicle 102 via actuator 124. In some examples, the energy storage device 106 may be omitted and the pump 150 and other components may be hydraulically powered.

Controller 112 may include a processor 140 and a memory 142. Memory 142 may hold instructions stored therein that when executed by the processor cause the controller 112 to perform various methods, control strategies, diagnostic techniques, etc. For example, the various methods may include adjusting the pressure applied to the valve plate in contact with pistons of the cylinder block with respect to drive shaft 120, to vary the amount of torque applied to drive shaft 120 (e.g., in response to an operator input). Processor 140 may include a microprocessor unit and/or other types of circuits. Memory 142 may include known data storage mediums such as random access memory, read only memory, keep alive memory, combinations thereof, etc. Memory 142 may include non-transitory memory.

Controller 112 may receive vehicle data and various signals from sensors positioned in different locations in motor 104 and/or vehicle 102. The sensors may include an oil temperature sensor 170, an engine velocity sensor 172, one or more wheel velocity sensors 174, and/or other sensors of motor 104 (e.g., torque sensors, pressure sensors, etc.). Controller 112 may send control signals to one or more actuators of motor 104, in response to operator input and/or based on the received signals from the sensors. For example, controller 112 may adjust a speed and/or torque generated on drive shaft 120 in response to operator input and/or based on the received signals from the sensors.

Motor system 100 may include one or more input devices 114. For example, input devices 114 may include a pedal of the vehicle (e.g., an accelerator pedal or a brake pedal), a control stick (e.g., a forward-neutral-reverse (FNR) lever), one or more buttons, or similar types of control, or combinations thereof. In one example, a FNR lever is used to operate the vehicle in a forward direction or a reverse direction, and an accelerator pedal is used to increase or decrease a speed of the vehicle. Likewise, a brake pedal or another braking input device, may be used with the braking system of motor 104 to decrease the rotational speed of the drive shaft 120 to the implement 110. The input devices 114, responsive to driver input, may generate a torque adjustment request and a desired drive direction (a forward or reverse drive direction). For instance, when a speed adjustment requested is received by the controller, an output speed of the motor 104 may be correspondingly increased.

Motor system 100 may automatically switch between drive modes when demanded. For example, the operator may request a forward or reverse drive mode speed change, and controller 112 may command motor 104 to increase speed and automatically transition between one or more drive ranges associated with the different drive modes, as needed. The motor system 100 may control the motor 104 and the implement 110 via the controller 112. The controller 112 may increase and decrease hydraulic pressure to drive the motor 104. Likewise, the controller may increase or decrease the hydraulic pressure to engage or disengage brakes of the motor 104. Engagement of the brakes may stop the rotational speed of the rotational elements of the motor 104. Disengagement of the brakes may remove braking torque and allow the rotational speed of the rotational elements to increase under the same input torque of the motor 104.

A set of reference axes 201 are provided for comparison between views shown in FIG. 2-8B. The reference axes 201 indicate a y-axis, an x-axis, and a z-axis. In one example, the z-axis may be parallel with a direction of gravity and the x-y plane may be parallel with a horizontal plane that a hydraulic motor assembly (HMA) 202 and components that may comprise the HMA 202 may rest upon. For this example, the z-axis may be a vertical axis, wherein the z-axis may be parallel with a vertical direction. For this example, the y-axis may be a longitudinal axis and the x-axis may be a lateral axis, wherein the y-axis may be parallel with a longitudinal direction and the x-axis may be parallel with a lateral direction relative to the HMA 202. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

Referring now to FIG. 2, a first view 200 of an embodiment of the HMA 202 is shown. The HMA 202 may be a non-limiting example of motor 104 described above in reference to FIG. 1. In the example of FIG. 2, the HMA 202 is an axial motor unit (AU). For this example, the HMA 202 is a swash plate motor. The HMA 202 may be driven my hydraulic pressure of work fluid, such as oil. The HMA 202 includes an example of the disclosed brake assembly.

The HMA 202 may be located about a central axis 204. The components of the HMA 202 may be positioned radially about the central axis 204. The central axis 204 is a longitudinal axis and is parallel with the y-axis of the reference axes 201.

The HMA 202 may have a first side 208 and a second side 209. The first side 208 and second side 209 are located at opposite ends of the HMA 202. The HMA 202 may be comprised of a plurality of housing. For an example of an embodiment, the housing of the HMA 202 may comprise a first housing and a second housing that are motor block housing 210 and a hydraulic block housing 212, respectively. The motor block housing 210 may house a rotary group 214 for the hydraulic motor of the HMA 202. The rotary group 214 may comprise the rotational elements and torque transferring elements of the HMA 202. The hydraulic block housing 212 may comprise a plurality of passages, channels, and chambers that supply the motor block housing 210 with work fluid. The work fluid may be used to actuate components housed in the motor block housing 210. Likewise, the work fluid may be used to lubricate components housed in the motor block housing 210. Additionally, the work fluid may be used to mitigate and regulate thermal energy, such that excess thermal energy may be removed from and/or deficits of thermal energy may be replaced for components housed in the motor block housing 210.

The components of rotary group 214 may be housed in a cavity 218 of the motor block housing 210. The rotary group 214 may include a shaft 216. The other components of the rotary group 214 may be positioned about the shaft 216. For example, the other components of the rotary group 214 may be positioned radially about the shaft 216 with respect to the central axis 204. The cavity 218 may be positioned radially about the central axis 204.

The motor block housing 210 may have a first mouth 220 and a second mouth 221 that are continuous with and fluidly coupled to the cavity 218. The first mouth 220 and second mouth 221 are located on opposite sides of the motor block housing 210, where the first mouth 220 is arranged closer to the first side 208 and the second mouth 221 is arranged closer to the second side 209 of the HMA 202. A first flange 222 may be located about the second mouth 221 and cavity 218. The first flange 222 may extend radially with respect to the central axis about the first mouth 220. The first flange 222 may be comprised of or joined to the material of the motor block housing 210. The first mouth 220 and first flange 222 may be located on the side of the motor block housing 210 opposite to the first side 208, with respect to the central axis 204.

The hydraulic block housing 212 may have a cavity 275. The cavity 275 may extend through the material of the hydraulic block housing 212. The cavity 275 may be positioned radially about the central axis 204. A second flange 224 may be located about the cavity 275. A portion of the second flange 224 may extend radially with respect to the central axis about the cavity 275. The second flange 224 may be comprised of or joined to the material of the hydraulic block housing 212. The second flange 224 may be located on the side of the hydraulic block housing 212 opposite to the first side 208, with respect to the central axis 204.

A plurality of appendages 228 may be located about the first mouth 220. The appendages 228 have a length that extends in longitudinal direction, with respect to the central axis 204, from the first side 208.

The first flange 222 and second flange 224 may be fastened at an interface 226. The interface 226 may be parallel with a x-z plane. When fastened at the interface 226, the first flange 222 and second flange 224 may fluidly couple the motor block housing 210 to the hydraulic block housing 212, such that the cavity 218 may be in fluid communication with the cavity 275. Likewise, when fastened via the interface 226, the motor block housing 210 and hydraulic block housing 212 may enclose the rotary group 214, such that components of the rotary group 214 may be housed in the cavity 218 and/or the cavity 275.

The cavity 218 may be fluidly coupled with a plurality of channels 238. Each of the channels 238 may extend through the material of the motor block housing 210 to at least one of a plurality of holes 236. Each of the holes 236 may be fluidly sealed by one of a plurality of first plugs 237. The holes 236 and portions of the channels 238 may extend through the material of a land 230. A plurality of holes 234 may also extend through the material of the land. Holes 236 and channels 238 may have centerlines at the same angle with respect to the central axis 204. Holes 234 may have centerlines approximately parallel with the central axis 204. The land 230 may be comprised of the material of the motor block housing 210. For an example embodiment, the motor block housing 210 may have a features that extend laterally outward with respect to or normal to the central axis 204. For example, a land 230 may extend about the central axis on a plane both laterally and vertically, with respect to the x-axis and z-axis of the reference axes 201. For an example embodiment, the land 230 may be disk shaped and extend radially with respect to the central axis 204. The land 230 may have a groove 232. The groove 232 may depress in a radial direction, with respect to the central axis 204, into the land 230.

The cavity 218 may have a plurality of diameters. For an example of an embodiment, the cavity 218 may have a first diameter 244, a second diameter 246, and a third diameter 248. For this example, the first diameter 244 may be a greater distance than the second diameter 246 and the third diameter 248. Likewise, the second diameter 246 may be a greater distance than the third diameter 248. The first diameter 244 may be the inner diameter of the first flange 222 and second mouth 221. The cavity 218 may include a drum section 240 in fluid communication and contiguous with the second mouth 221. The first flange 222 may extend toward the second side 209 from a drum section 240. The drum section 240 may be a surface formed about the outer boundary of a hole 242. The drum section 240 may house or be concentric to the components of a braking assembly of a drum brake configuration. Brake torque may be applied to rotary group 214 within the circumference of the drum section 240. Hole 242 may be located approximately radially about the central axis 204. The second diameter 246 may be the inner diameter for the drum section 240 and hole 242.

The first diameter 244, second diameter 246, and third diameter 248 may be located radially about the shaft 216. Likewise, the first diameter 244, second diameter 246 and third diameter 248 may be located radially about portions of the rotary group 214. A plier assembly 252 of the brake assembly may be located about the rotary group 214. Likewise, the drum section 240 and hole 242 may be located about the plier assembly 252. The plier assembly 252 may be the drum brake component and brake shoes of a drum brake system. A valve plate 250 may be positioned longitudinally between the rotary group 214 and the hydraulic block housing 212. The valve plate 250 may be concentric to the first flange 222 and located about the shaft 216.

The rotary group 214 may comprise a cylinder block 254, a swash plate 256, a plurality of pistons 258, a plurality of slippers 260, and a carrier 262. The plier assembly 252 may be located about the cylinder block 254. The plier assembly 252 may comprise a pair of pliers. The pliers of the plier assembly 252 may be a pair of brake pads or brake shoes joined together by a pin and having a common pivot point. The pliers are curved structures that may comprise braking pads at each inner surface of each plier. In one example, the braking pads of the pliers are arched braking pads that comprise the high-friction inner surface of each of the pliers. The slippers 260 may be supported by and physically coupled to the carrier 262. The cylinder block 254 may have a plurality of a piston chambers 264. The piston chambers may be a positioned radially about the centerline of the cylinder block 254. Likewise, the piston chambers 264 may be positioned radially about the central axis 204. Each of the piston chambers 264 may be complementary to the pistons 258. Each of the pistons 258 may be housed in a chamber of the piston chambers 264 and be drivingly coupled to a slipper 260. Each of the pistons 258 may have a cavity 266 in fluid communication with a complementary chamber of piston chambers 264. A first bearing 268 may be located about the shaft 216 and portions of the cylinder block 254. Likewise, the carrier 262 and portions of the swash plate 256 may be located about the first bearing 268. The first bearing 268 may support and allow the carrier 262 to spin about the shaft 216 and central axis 204.

Each of the pistons 258 may be actuated in a longitudinal direction via pressure changes of work fluid (e.g. hydraulic pressure) in the chamber of chambers 264. Work fluid may be directed into the chambers 264 and cylinder block 254 from the hydraulic block housing 212 via the valve plate 250. Increase in work fluid pressure to a chamber of chambers 264 may slide a complementary piston of pistons 258 toward the first side 208. Increase in pressure to the chamber of chambers 264 may slide the complementary piston of pistons 258 toward the second side 209. The cyclical motion of the pistons 258 in their complementary chamber of chambers 264 may drive the slippers 260 and swash plate 256 to rotate about the central axis 204. The swash plate 256 may be drivingly coupled to the cylinder block 254 via the slippers 260 and pistons 258, such that the cylinder block 254 may rotate in the direction of the swash plate 256. Likewise, the shaft 216 may be drivingly couple to the cylinder block 254, such that the shaft 216 may rotate in the direction of the cylinder block 254. Each of the slippers 260 may be physically coupled to the swash plate 256.

A plurality of components may be located about the shaft 216. For example, there may be a seal 270 located about the shaft 216. Likewise, a second bearing assembly 272 and a third bearing assembly 274 may be located about and support the shaft 216. The seal 270 may be positioned longitudinally between the first mouth 220 and the second bearing assembly 272. The second bearing assembly 272 may be located longitudinally between the first mouth 220 and the swash plate 256. Likewise, the third bearing assembly 274 may be housed by the cavity 275. The cavity 275 may be located radially about the third bearing assembly 274. A plurality of springs 276 and a plate 278 may be located about the shaft 216. The springs 276 and plate 278 may be housed within a cavity 277 of the cylinder block 254. The cavity 277 may be concentric to the cylinder block 254 and located radially about the shaft 216 with respect to the central axis 204.

A fastener 282 may extend through a plurality of complementary holes of the plier assembly 252. The fastener 282 may be a pin. When passed through the holes, the fastener 282 may fasten the components of the plier assembly 252 together. The fastener 282 may also extend through a complementary hole 283 in the material of the motor block housing 210. When threaded or extending through the complementary hole 283, the fastener 282 may fasten the plier assembly 252 to the motor block housing 210.

The shaft 216 may have an opening 284. When the shaft 216 is in place, the opening 284 may be positioned to be at the first side 208 and concentric to the first mouth 220. The opening 284 may receive an input from a rotational element, such as another shaft or a gear. When received by the opening 284, the input from the rotational element may be drivingly coupled to the shaft 216, such that rotational energy via torque may be transferred from the shaft 216 to the rotational element or vice versa. The opening 284 may have a plurality of splines. The splines of the opening 284 may be complementary to a plurality of splines of the aforementioned input. When the splines of the opening 284 and the input are threaded, the shaft 216 may be drivingly coupled to the input.

Work fluid may be transported through the hydraulic block housing 212 via a plurality of passages, such as a first passage 286, a second passage 288, and a third passage 290. The first passage 286 may deliver work fluid to the second mouth 221 and cavity 218. Some of the passages of the hydraulic block housing 212 may be sealed via plugs. For example, the first passage 286 may be sealed via a second plug 292 and third plug 294. For this and other examples, the third passage 290 may be sealed via a fourth plug 296 and a fifth plug 298.

Referring now to FIG. 3A and FIG. 3B, a second view 300 of the HMA 202 is shown. The second view 300 is a second sectional view taken on a line perpendicular to the first view 200. The second view 300 shows a first line 306 and a second line 308. A third sectional view may be taken on the first line 306, (third view 400 shown in FIG. 4). Likewise, a fourth sectional view may be taken on second line 308, (fourth view 500 shown in FIG. 5).

The second view 300 shows a brake assembly 314. The brake assembly 314 may include components used to stop the rotation of components of the rotary group 214. Components of brake assembly 314 are enclosed by a plurality of dashed lines. The brake assembly 314 may include the plier assembly 252. The plier assembly 252 may serve as the drum brake component and the brake shoes of the brake assembly 314.

FIG. 3A illustrates features the HMA 202 from the second view 300 that are not shown in FIG. 3B and vice versa. For example, there are channels and passages enabling fluid transport and communication for actuating the pistons 258 that are labeled in FIG. 3A and not in FIG. 3B. Likewise, there are channels and passages enabling fluid transport and communication for actuating components of the brake assembly 314 that are labeled in FIG. 3B and not in FIG. 3A.

Turning to FIG. 3A, the brake assembly 314 comprises an actuator system. A hydraulic piston assembly may comprise and actuate the actuator system and brake assembly 314. The hydraulic piston assembly may comprise the components of the brake assembly 314 including the cylinder block 254 and the plier assembly 252, wherein the plier assembly 252 comprises a pair of braking pads. The hydraulic piston assembly may also comprise a hydraulic block, such as the hydraulic block housing 212, which may fluidly couple the actuator system and other components of the brake assembly 314. When fluidly couple to the actuator system, hydraulic block housing may transport and increase the pressure of work fluid for actuation such that brake assembly 314 may change states, such as from closed (e.g., braking) to open (e.g., not braking).

The actuator system may be located about the plier assembly 252 and may comprise a plurality of chambers that each house an actuator comprising a piston and a spring. Each of the chambers and their complementary actuators may be located radially about the central axis 204. Each of chambers may extend radially away from the central axis 204 through the material of the motor block housing 210. Each chamber may have a complimentary hole, via which an actuator may be actuated through. Each actuator may be actuated closer to or away from the plier assembly 252 in a direction normal to the central axis 204. The actuators of the actuator system may be actuated hydraulically, by increasing or decreasing the pressure of work fluid to the chambers.

For the example embodiment shown in the second view 300, the actuator system may comprise at least two chambers with two complimentary actuators. The actuator system may have a first chamber 332a that may house a first actuator 334a. The actuator system may have a second chamber 332b that may house a second actuator 334b. The first actuator 334a and second actuator 334b comprise a first spring 336a supporting a first piston 335a and second spring 336b supporting a second piston 335b, respectively. As pistons, the first actuator 334a and second actuator 334b that may be actuated via hydraulic pressure of the first chamber 332a and second chamber 332b. The first chamber 332a and first actuator 334a may be arranged such as to have centerlines that are perpendicular to the central axis 204. Likewise, the second chamber 332b and second actuator 334b may be arranged such as to have centerlines that are perpendicular to the central axis 204.

When actuated, portions of first actuator 334a may pass through a first hole 330a to the first chamber 332a. Likewise, when actuated, portions of the second actuator 334b may pass through a second hole 330b to the second chamber 332b. The first hole 330a and second hole 330b may extend in a radial direction with respect to the central axis 204 through the material of the drum section 240. The first chamber 332a and second chamber 332b may be of the same dimensions and may be mirrored on opposite sides of the central axis 204. The first actuator 334a and second actuator 334b may be of the same dimensions and may be mirrored on opposite sides of the central axis 204. The first hole 330a and second hole 330b may be of the same dimensions and may be mirrored on opposite sides of the central axis 204. The first hole 330a may allow the first actuator 334a to slide toward and partially into the hole 242. The second hole 330b may allow the second actuator 334b to slide toward and partially into the hole 242. After sliding into the hole 242, the first actuator 334a and second actuator 334b may make surface sharing contact with the plier assembly 252.

The first spring 336a may be positioned between the first piston 335a and a surface of the first chamber 332a. The first spring 336a may support and transfer spring force to the first actuator 334a. Likewise, the second spring 336b may be positioned between the second piston 335b and a surface of the second chamber 332b. The second spring 336b may support and transfer spring force to the second actuator 334b. The spring force of the first and second springs 336a. 336b may translate the first actuator 334a and second actuator 334b, respectively, in a direction normal to the central axis 204. If in surface sharing contact with the plier assembly 252, the first actuator 334a may press and transfer the spring force of the first spring 336a to a surface of the plier assembly 252 and radially toward the central axis 204. If in surface sharing contact with the plier assembly 252, the second actuator 334b may press and transfer the spring force of the second spring 336b to a surface of the plier assembly 252 and radially toward the central axis 204. Such a transfer of force may compress the plier assembly 252.

The first actuator 334a and second actuator 334b may also be actuated hydraulically. An increase in the pressure of work fluid (e.g., hydraulic pressure) to the first chamber 332a and second chamber 332b may actuate the first actuator 334a and second actuator 334b, respectively, away from the central axis 204. For example, pressure of work fluid to the first and second chambers 332a, 332b may be increased such that a force from the pressure is greater than and opposite to the spring force of the first spring 336a and second spring 336b, respectively. When the spring force of the first spring 336a and second spring 336b are surpassed, the first actuator 334a and second actuator 334b may be actuated radially away from the central axis 204. When actuated in a radial direction from the central axis 204, the first actuator 334a and second actuator 334b may not be in surface sharing contact with or apply force to the plier assembly 252. The reduction and removal of force transferred from the first actuator 334a and second actuator 334b, may release the plier assembly 252 from surface sharing contact with the cylinder block 254.

The plier assembly 252 may be of a first inner diameter 342 or a second inner diameter 344. The first inner diameter 342 may be a greater distance than the second inner diameter 344. The first inner diameter 342 is a distance such that the plier assembly 252 may not be in surface sharing contact with the cylinder block 254. The second inner diameter 344 is a distance such that the plier assembly 252 may be in surface sharing contact with the cylinder block 254.

The brake assembly 314 may be engaged when pressure of work fluid is reduced to the first chamber 332a and second chamber 332b such that the first actuator 334a and second actuator 334b are in surface sharing contact with and transfer forces to the plier assembly 252. When in surface sharing contact with the first actuator 334a and second actuator 334b, the spring force of the first spring 336a and second spring 336b may be transferred from the first actuator 334a and second actuator 334b, respectively, to the plier assembly 252. The transfer of the spring force through the first and second actuators 334a, 334b may cause the plier assembly 252 to compress from the first inner diameter 342 to the second inner diameter 344. When in surface sharing contact with the cylinder block 254, the plier assembly 252 may apply a braking torque to the cylinder block 254 via friction.

On the first side 208 of the motor block housing 210 there may be a plurality of holes that may be used for mounting motor block housing 210 to a complimentary component. For example, there may be first hole 322 and second hole 324. The first and second holes 322, 324 may have centerlines that are approximately longitudinal with the motor block housing 210 and may be parallel with the central axis 204. The first hole 322 may extend through the material of one of the appendages 228. There may be a plurality of holes of approximately the same dimensions as the first hole 322 about the first mouth 220. Each of these aforementioned holes may extend through each of the appendages 228 as the first hole 322. The second hole 324 may be located above the first mouth 220 and extend through the material of the motor block housing 210. There may be a plurality of holes sharing the same dimensions as the second hole 324 located about the first mouth 220 The holes are used for mounting the motor block housing 210 to the machine, e.g., vehicle 102.

Closer to the second side 209 from the first side 208, the second view 300 shows a plurality of additional passages of the hydraulic block housing 212 that work fluid may be transported through. Such passages include a fourth passage 352, a fifth passage 354, a sixth passage 356, and an eighth passage 358. The fifth passage 354 and sixth passage 356 may place the hydraulic block housing 212 in fluid communication with the motor block housing 210. The fifth passage 354 and sixth passage 356 may be in fluid communication with the cylinder block 254 via the valve plate 250.

The eighth passage 358 may be fluidly coupled and in fluid communication with a port 362. The port 362 may be fluidly coupled to a supply of work fluid. Fluid may enter the hydraulic block housing 212 via the port 362. The port 362 may have and be fluidly coupled to a plurality of components shown partially exploded from the other components of the HMA 202. For example, the port 362 may be hydraulically coupled to a first component 364, a second component 366, a third component 368, and a fourth component 370 comprising a valve. The valve over center ensures flow stop and controlled load descent thereby reducing cavitation. The valve may protects the circuit from pressure increases and allows free passage in the opposite direction.

The piston chambers 264 of the cylinder block 254 may be supplied with work fluid via a plurality of holes of the valve plate 250 and a plurality of passages of the hydraulic block housing 212. For example, the valve plate 250 may have a third hole 372 and a fourth hole 376. The third hole 372 may be in fluid communication and fluidly couple to the fifth passage 354. The fourth hole 376 may be in fluid communication and fluidly couple to the sixth passage 356. The side of the cylinder block 254 positioned nearest to the valve plate 250 may have a plurality of holes allowing work fluid to be passed to the piston chambers 264. For example, a fifth hole 374 may be in fluid communication and fluidly couple to a first piston chamber of piston chambers 264. Likewise, a sixth hole 378 may be in fluid communication and fluidly coupled to a second piston chamber of the piston chambers 264. In second view 300, the cylinder block 254 is positioned such that the third hole 372 is in fluid communication with the fifth hole 374 and the fourth hole 376 is in fluid communication with the sixth hole 378. As the cylinder block 254 rotates about the central axis 204, the third hole 372 and fourth hole 376 may cycle between being in fluid communication with the fifth and sixth holes 374, 378; other holes similar in dimension and function to the fifth and sixth holes 374, 378 to other piston chambers of piston chambers 264; and out of fluid communication with the piston chambers 264.

Turning to FIG. 3B, the second view 300 shows additional passages of the hydraulic block housing 212, such as an eighth passage 382, a ninth passage 384, an eleventh passage 388, and a twelfth passage 390. Likewise, the second view 300 shows additional passages of the motor block housing 210 such as a tenth passage 386 and a thirteenth passage 392.

The eighth passage 382 and eleventh passage 388 may be positioned radially about the central axis 204. The eighth passage 382 and eleventh passage 388 may partially or fully circumferentially surround the central axis 204. The ninth passage 384 and twelfth passage 390 may be positioned about the central axis 204. The ninth passage 384 and twelfth passage 390 may have centerlines that are longitudinal and may be parallel with the central axis 204. Likewise, the tenth passage 386 and the thirteenth passage 392 may be positioned about the central axis 204. The tenth passage 386 and thirteenth passage 392 may have centerlines that are longitudinal and may be parallel with the central axis 204. For an example embodiment, the eighth passage 382, the ninth passage 384, the eleventh passage 388, and the twelfth passage 390 may be comprised of the material of the second flange 224. For this example, the tenth passage 386 and thirteenth passage 392 may be comprised of the material of the first flange 222.

The eighth passage 382 may be in fluid communication with and fluidly coupled to the ninth passage 384. The ninth passage 384 may be in fluid communication with and fluidly coupled to the tenth passage 386. The tenth passage 386 may be in fluid communication with and fluidly coupled to the first chamber 332a.

The eleventh passage 388 may be in fluid communication with and fluidly coupled to the twelfth passage 390. The twelfth passage 390 may be in fluid communication with and fluidly coupled to the thirteenth passage 392. The thirteenth passage 392 may be in fluid communication with and fluidly coupled to the second chamber 332b.

Work fluid may pass through the eighth passage 382, ninth passage 384, and tenth passage 386 to fill a volume of and lubricate the first chamber 332a. Work fluid may pass through the eleventh passage 388, twelfth passage 390, and thirteenth passage 392 to fill a volume of and lubricate the second chamber 332b. When work fluid fills the first chamber 332a, hydraulic pressure from work fluid in the first chamber 332a may exert force on the first actuator 334a. When work fluid fills the second chamber 332b, pressure from work fluid in the second chamber 332b may exert force on the second actuator 334b.

The fluid flow from the hydraulic block 212 to the first chamber 332a, second chamber 332b, and other components and features of the actuator system may selectively control the compressing and releasing of the plier assembly 252 about the cylinder block 254. For example, when the work fluid is increased to a pressure above a first threshold pressure in the first chamber 332a, a force opposite to and greater than the spring force of the first spring 336a may be exerted on the first actuator 334a. Likewise, when the work fluid is increased to a pressure above a first threshold pressure in the second chamber 332b, a force opposite to and greater than the spring force of the second spring 336b may be placed on the second actuator 334b. The first actuator 334a and second actuator 334b may move radially away from the central axis 204 and the plier assembly 252, and the brake assembly 314 may be placed in a disengaged state. When in a disengaged state, the components of the brake assembly 314 may allow the cylinder block 254 to rotate about the central axis 204 without resistance from a braking torque, such as when the brake assembly 314 has the first inner diameter 342.

A first brake signal from a brake pedal or another braking input device, may increase brake pressure above the first threshold pressure in the first and second chambers 332a, 332b to actuate the first and second actuators 334a, 334b, respectively, to disengage the brake assembly 314. Likewise, a second signal from a brake pedal or another braking device, may decrease the pressure above the first threshold pressure in the first and second chambers 332a, 332b to actuate the first and second actuators 334a. 334b, respectively, to engage the brake. The input devices 114 of FIG. 1 may comprise a single or plurality of braking devices that may send signals to engage or signals to disengage the brake assembly 314.

It is to be appreciated, that the eighth passage 382 and eleventh passage 388 may be fluidly coupled, such that fluid may be split to enter the eighth passage 382 and eleventh passage 388 in similar volumes. It is also to be appreciated, that the eighth passage 382 and eleventh passage 388 may be continuous with one another and part of a combined passage.

Referring now to FIG. 4, a third view 400 of an embodiment of the HMA 202 of FIGS. 2-3B is shown. The third view 400 may be a third sectional view taken on the first line 306 shown in FIGS. 3A-3B. The third view 400 shows a cut from a perspective negative to the y-axis. The third view 400 shows the motor block housing 210 and does not show hydraulic block housing 212. The motor block housing 210 may have a first side 402 and a second side 404. In third view 400, the first side 402 is positioned in positive x direction relative to the reference axes 201. Likewise, in the third view the second side 404 is positioned in the negative x direction relative to the reference axes 201.

The third view 400 shows a third line 406 and a fourth line 408. The first view 200 of FIG. 2 may be taken on the third line 406. Likewise, the second view 300 of FIGS. 3A-3B may be taken on the fourth line 408. The third view 400 shows surface 410 of the land 230 that is parallel with a plane formed by the x-z axes of the reference axes 201.

The third view 400 shows the plier assembly 252 may comprise a first plier 434 and a second plier 436. The first plier 434 and second plier 436 may each be a brake shoe or a brake pad. The first plier 434 may be positioned nearest to the first side 402 and the second plier 436 may be positioned nearest to the second side 404. The first plier 434 and second plier 436 may be fastened to comprise plier assembly 252 via the fastener 282. The first plier 434 and second plier 436 may be fastened to comprise plier assembly 252 via the fastener 282 and a joint 438, such as a hinge. The components and features the joint 438 may be enclosed by a box of dashed lines. The joint 438 may be formed by structures with holes complementary to the fastener, such as knuckles, from the first plier 434 and second plier 436. When the complementary holes of the joint 438 are aligned, such that the centerlines of the complementary holes are approximately collinear, the fastener may be passed through the joint 438 to fasten the first plier 434 and second plier 436 into the plier assembly 252. Likewise, the first plier 434 and second plier 436 may be fastened to the motor block housing 210 via the fastener 282.

The joint 438 may also be a common pivot point for the first plier 434 and second plier 436. For example, force may be applied from the first actuator 334a to the first plier 434. The joint 438 may allow for force applied to first plier 434 to pivot the first plier 434 about the fastener 282. Likewise, force may be applied from the second actuator 334b to the second plier 436. Joint 438 may allow for force applied to the second plier 436 to pivot the second plier 436 about the fastener 282. The pivoting of the first plier 434 and/or second plier 436 about the fastener 282, may decrease a distance 448 between the first plier 434 and second plier 436. As the distance 448 between the first plier 434 and second plier 436 is decreased, the inner diameter of the plier assembly 252 may be decreased in distance.

The third view 400 shows a plurality of holes 442 with centerlines that extend in a longitudinal direction through the material of cylinder block 254. The plurality of holes 442 may include the fifth hole 374 and sixth hole 378 of FIGS. 3A-3B.

Referring now to FIG. 5, a fourth view 500 of an embodiment of the HMA 202 of FIGS. 2-3B is shown. The fourth view 500 may be a fourth sectional view taken on the second line 308 shown in FIGS. 3A-3B. The fourth view 500 shows a cut from a perspective negative to the y-axis. The fourth view 500 shows the motor block housing 210 and does not show hydraulic block housing 212.

The fourth view 500 shows the fastener 282 may fasten the plier assembly 252 to the motor block housing 210, such that an outer surface 516a of the first plier 434 and an outer surface 516b of the second plier 436 are not in surface sharing contact with an inner surface 512 of the drum section 240. The outer surface 516a and outer surface 516b may be separated from the inner surface 512 by a clearance 514. A portion of the joint 438 about the fastener 282 may be closer to the inner surface 512 near a groove 518. The groove 518 may curve about the joint 438 and fastener 282 when the plier assembly 252 is mounted to the motor block housing 210.

The fourth view 500 is a cut approximately parallel with the centerlines of the first hole 330a, second hole 330b, first chamber 332a, and second chamber 332b. Likewise the fourth view 500 may cut approximately parallel to the centerlines of the first actuator 334a, and the second actuator 334b when housed in the first chamber 332a and the second chamber 332b, respectively. The fourth view 500 shows an area 520 that may be enclosed by a box formed of a plurality of dashed lines. The area 520 may enclose the hole 330b and second chamber 332b. Area 520 may also enclose portions of the plier assembly 252, cylinder block 254, and the motor block housing 210.

A fourth bearing assembly 522a may be positioned between the first hole 330a and first chamber 332a. The fourth bearing assembly 522a may support and allow the first actuator 334a to slide in a direction normal to the central axis 204 toward and away from the plier assembly 252. For this example, the fourth bearing assembly 522a may allow the first actuator 334a to move laterally with respect to the central axis 204. The fourth bearing assembly 522a may be located about a portion of the first actuator 334a. Similarly, a fifth bearing assembly 522b may be positioned between the second hole 330b and second chamber 332b. The fifth bearing assembly 522b may support and allow the second actuator 334b to slide in a direction normal to the central axis 204 toward or away from the plier assembly 252. For this example, the fifth bearing assembly 522b may allow the second actuator 334b to move laterally with respect to the central axis 204. The fifth bearing assembly 522b may be located about a portion of the second actuator 334b.

Located between the first spring 336a and the fourth bearing assembly 522a may be the first piston 335a. The first piston 335a may comprise the material of or be joined to the first actuator 334a. The first piston 335a may extend radially with respect to the centerline of the first actuator 334a. The first piston 335a may be acted upon by work fluid, such that the force of work fluid may push on the first piston 335a in a direction opposite to the spring force of the first spring 336a. Additionally, the first piston 335a may act as a lock. The first piston 335a may prevent the first spring 336a from pushing the first actuator 334a a distance past the fourth bearing assembly 522a, as the first piston 335a abuts the fourth bearing assembly 522a. Similarly, located between the second spring 336b and the fifth bearing assembly 522b may be the second piston 335b. The second piston 335b may comprise the material of or be joined to the second actuator 334b. The second piston 335b may extend radially with respect to the centerline of the second actuator 334b. The second piston 335b may be acted upon by work fluid, such that the force of work fluid may push on the second piston 335b in a direction opposite to the spring force of the second spring 336b. Additionally, the second piston 335b may act as a lock. The second piston 335b may prevent the second spring 336b from pushing the second actuator 334b a distance past the fifth bearing assembly 522b, as the second piston 335b abuts the fifth bearing assembly 522b.

View 500 shows the shaft 216 may have a plurality of splines 542. The splines 542 may be positioned radially about the outer surface of the shaft 216 with respect to the central axis 204. When splines 542 are intermeshed with complementary splines of the cylinder block 254, the cylinder block 254 may be drivingly coupled to and transfer rotational energy via torque to the shaft 216.

Referring now to FIG. 6, a fifth view 600 of an embodiment of the cylinder block 254 is shown. The fifth view 600 shows the cylinder block 254 isolated from the motor block housing 210 and other components of the rotary group 214. In the fifth view 600, the cylinder block 254 is centered about the central axis 204.

The cylinder block 254 may have a first end 612 and a second end 614. The first end 612 is opposite the second end 614. The first end 612 may face and be positioned nearest to the swash plate 256, slippers 260, and carrier 262 of the rotary group 214 shown in FIG. 2. The second end 614 may be positioned nearest to the third bearing assembly 274 and hydraulic block housing 212 of FIG. 2.

The cylinder block 254 may have a first surface 622, a second surface 624, and a third surface 626. The first surface 622 may be on the first end 612. The first surface 622 may be approximately flat or concave. The second surface 624 and third surface 626 may be located about the central axis 204. The second surface 624 may be nearer to the first end 612 compared to the third surface 626, and sandwiched between the first surface 622 and third surface 626. The third surface 626 may be nearer to the second end 614 compared to the second surface 624. For an example embodiment, the second surface 624 and third surface 626 are cylindrical in shape and have areas that are radial with respect to the central axis 204. The second surface 624 and third surface 626 are outer surfaces of the cylinder block 254. The second surface 624 may circumferentially surround and be bounded to a first diameter 628. The third surface 626 may circumferentially surround and be bounded to a second diameter 630. The first diameter 628 may be a greater distance than the second diameter 630.

The first surface 622 and third surface 626 may be smooth with a low coefficient of friction for rotation. In one example, the second surface 624 has a high coefficient of friction, and therein may be a high-friction outer surface for the cylinder block 254. The high coefficient of friction of the second surface 624 may generate frictional force when in surface sharing contact with features of the plier assembly 252. The frictional force may produce a braking torque counter to the torque spinning the cylinder block 254 in a direction about the central axis 204.

In another example, the second surface 624 may be an interference bushing located about the cylinder block 254 and complementary to a bearing. The second surface 624 comprising the interference bushing and bearing may generate a frictional force when in surface sharing contact with the features of the plier assembly 252. The frictional force may produce a braking torque counter to the torque spinning the cylinder block 254 in a direction about the central axis 204.

The cylinder block 254 may have a receiving hole 632 for a shaft, such as shaft 216. A ring 634 may extend longitudinally from the first surface 622. The ring may be located about and provide mechanical support to a portion of the receiving hole 632. The receiving hole 632 may extend through the cylinder block 254 to the cavity 277 of FIG. 2. The receiving hole 632 may have a plurality of splines 636. The splines 636 may be positioned radially with respect to the central axis 204 about the inner surface of the receiving hole 632. The splines 636 may be complementary to the splines 542 shown in FIG. 5.

Referring now to FIG. 7, a sixth view 700 of an embodiment of the plier assembly 252 is shown. The sixth view 700 shows the plier assembly 252 isolated from the motor block housing 210 and other components of the brake assembly 314 of FIGS. 3A-3B. In the sixth view 700, the plier assembly 252 is centered about the central axis 204.

The plier assembly 252 may have a plurality of inner surfaces and outer surface. The inner surfaces of the plier assembly may be of or coated with a material of a high coefficient of friction. The braking pads of the brake assembly 314 may comprise the inner surfaces of the plier assembly 252. The outer surfaces of the plier assembly 252 may make surface sharing contact and be pressed upon by the actuators of the brake assembly 314, such as the first actuator 334a and second actuator 334b of FIGS. 3A-3B. For example, the first plier 434 may have a first inner surface 722a with a high coefficient of friction. For this example, the second plier 436 may have a second inner surface 722b with a high coefficient of friction. The first plier 434 may have a first outer surface 724a and the second plier 436 may have a second outer surface 724b. The first inner surface 722a and first outer surface 724a may arch with the shape and curvature of the first plier 434. Likewise, the second inner surface 722b and second outer surface 724b may arch with the shape and curvature of the first plier 434. The first outer surface 724a may have surface sharing contact with and be pressed upon by the first actuator 334a. The second outer surface 724b may have surface sharing contact with and be pressed upon by the second actuator 334b.

Each of the pliers of the plier assembly may comprise a braking pad. And each braking pad may comprise a high-friction inner surface of the plier. For example, the first plier 434 may comprise a braking pad. Likewise, the second plier 436 may comprise a braking pad. The braking pad of the first plier 434 may comprise the first inner surface 722a. The braking pad of the second plier 436 may comprise the second inner surface 722b. The first inner surface 722a may be a braking pad for the first plier 434. The second inner surface 722b may be a braking pad for the second plier 436.

The high-friction inner surfaces of the braking pads and high-friction outer surface of the cylinder block 254 may enable braking. For example, when positioned around the cylinder block 254, compressing first inner surface 722a and second inner surface 722b against the outer surface of the cylinder block 254 may realize braking. The first inner surface 722a and/or second inner surface 722b may have surface sharing contact with the second surface 624 of FIG. 6, such as during compression of the plier assembly 252.

The first inner surface 722a and second inner surface 722b may have surface sharing contact with the second surface 624, when the first actuator 334a presses against the first outer surface 724a and the second actuator 334b presses against the second outer surface 724b. When the first inner surface 722a has surface sharing contact with the second surface 624, the force of friction may generate a braking torque in a direction opposite to a direction the second surface 624 may rotate about the central axis 204. Likewise, when the second inner surface 722b has surface sharing contact with the second surface 624, the force of friction may generate a braking torque in a direction opposite to a direction the second surface 624 may rotate about the central axis 204.

For another example, when positioned around the cylinder block 254, releasing of the first inner surface 722a and second inner surface 722b from outer surface of the cylinder block 254 may realize the removal of a braking torque. During release (decompression) of the plier assembly 252, the first inner surface 722a and/or second inner surface 722b may not be surface sharing contact with the second surface 624 of FIG. 6. Without braking, the rotation of the cylinder block 254 may increase from when braking was realized.

The fastener 282 may be comprised of a head 732 and a shank 736. The head 732 may have an opening 734. The opening 734 may act as a receiver, such as drive or key hole, fit to an implement, such as an Allen wrench. The implement may be used to rotate and press or pull the fastener from the joint 438 of FIG. 4. The shank 736 may have a first section that is smooth and a second section that is threaded. The first section of the shank 736 may be passed through and concentric to the complementary holes of the joint 438. The second section of the shank 736 may be located on the end of the fastener 282 opposite to the head 732. The second section of the shank 736 may be inserted into a complementary hole of the motor block housing 210, such as hole 283 of FIG. 2.

The joint 438 may be comprise of a plurality of knuckles and volumes of the first plier 434 and second plier 436. For an example embodiment, the plier assembly 252 may have a first knuckle 752, a second knuckle 754, and a third knuckle 756. Likewise, the plier assembly 252 may have a first notch 762, a second notch 764, and a third notch 766. For the embodiment shown in sixth view 700, the first plier 434 may comprise the first knuckle 752, the second notch 764, and third knuckle 756. For this embodiment, the second plier 436 may comprise the first notch 762, the second knuckle 754, and the third notch 766.

The first knuckle 752, the second knuckle 754, and the third knuckle 756 may each have a hole complementary to the shank 736, such that the first knuckle 752, second knuckle 754, and third knuckle 756 may be positioned about portions of the shank 736. The first notch 762 may be complementary to the first knuckle 752, such that when distance 448 is decreased, the first knuckle 752 may rotate about the shank 736 and not abut the second plier 436. The second notch 764 may be complementary to the second knuckle 754, such that when distance 448 is decreased the second knuckle 754 may rotate about the shank 736 and not abut the first plier 434. The third notch 766 may be complementary to the third knuckle 756, such that when distance 448 is decreased the third knuckle 756 may rotate about the shank 736 and not abut the second plier 436.

Referring now to FIG. 8A and FIG. 8B, a seventh view 800 and an eighth view 850 are shown of area 520. The seventh view 800 shows area 520 when the second actuator 334b is in a first position. The eighth view 850 shows area 520 when the second actuator 334b is in a second position. When in the first position, the second actuator 334b is engaged, such as to transfer force to the second plier 436. When in the second position, the second actuator 334b is disengaged, such as to not transfer force to the second plier 436. The second actuator 334b may be placed in the second position of eighth view 850 from the first position in the seventh view 800 by increasing the pressure of work-fluid to the second hole 330b and second chamber 332b above a first threshold pressure.

As shown in the seventh view 800 and eighth view 850, the bearings of the fifth bearing assembly 522b may be supported by a race 818. The race 818 may be fit to a first groove 816. The first groove 816 may be positioned between the second hole 330b and the second chamber 332b. The first groove 816 may extend radially with respect to a centerline 812 of the second chamber 332b into the material of the motor block housing 210. The first groove 816 may be a part of and continuous with the second chamber 332b.

When fit to the first groove 816, the race 818 may remain stationary. The first groove 816 and race 818 may be positioned about portions of the second actuator 334b, such as the first surface 821. The first surface 821 may be a sliding surface of the second actuator 334b. The first surface 821 may be cylindrical and curve radially about the centerline of the second actuator 334b. The first surface 821 may be in surface sharing contact with components of the fifth bearing assembly 522b such as the inner surface of the race 818. The second spring 336b may be sandwiched between a portion of the second piston 335b and a first surface 820. The first surface 820 may be normal to the centerline 812 and may be on the opposite end of the second chamber 332b from the second hole 330b. The second spring 336b may be located radially, with respect to the centerline 812 about an extension 823 of the second actuator 334b. The extension 823 may extend parallel with the centerline 812 from the second piston 335b toward the first surface 820.

The second chamber 332b may be formed of a plurality of sections of varying diameters. For an example of an embodiment, the second chamber 332b may have a first diameter 822, a second diameter 824, and a third diameter 826. The first diameter 822 may be of a greater distance than the second and third diameters 824, 826. The second diameter 824 may be of a greater distance than the third diameter 826. The first diameter 822 may be the diameter of the first groove 816. The second diameter 824 may be a diameter of a first section of the second chamber 332b. The third diameter 826 may be a diameter of a second section of the second chamber 332b. The first section bounded by the second diameter 824 may be where the second piston 335b may be translated in directions parallel with the centerline 812 when housed in the second chamber 332b. The diameter of the second piston 335b may be approximately less than or equal to the second diameter 824. The second section bounded by the third diameter 826 may be where the second spring 336b may be compressed. The second section bounded by the third diameter 826 may allow the extension to pass into. A second surface 830 may abut and prevent the second piston 335b from sliding into the section bounded by the third diameter 826. A first o-ring seal 832 and a second o-ring seal 834 may be positioned around the second piston 335b inside a race 818.

Turning to FIG. 8A, the seventh view 800 shows the second actuator 334b is in a first position when the second piston 335b is a first distance 828 from the first surface 820. When at the first distance 828, a head 844 of the second actuator 334b may be in surface sharing contact with the second plier 436. Between the head 844 and the second piston 335b, the second actuator 334b may have a fourth groove 846. The fourth groove 846 may be positioned radially, with respect to the centerline 812, about the second actuator 334b. The fourth groove 846 may provide a ring shaped like volume for work-fluid to accumulate. Work fluid may enter and accumulate about the fourth groove 846 from passages fluidly coupled to the second chamber 332b, such as the tenth passage 386 of FIG. 3B. Work fluid about the fourth groove 846 may place a force on the second piston 335b opposite to the force of the spring force from the second spring 336b. As the pressure of the work fluid about the fourth groove 846 increases, the force against the second piston 335b may increase.

Turning to FIG. 8B, the eighth view 850 shows the second actuator 334b is in a second position when the second piston 335b is at a second distance 872 from the first surface 820. The second distance 872 may be smaller than the first distance 828 of FIG. 8A. When the second piston 335b is at the first distance 828 from the first surface 820, the head 844 of the second actuator 334b may be in surface sharing contact with the second plier 436. When the piston 335b is at the second distance 872 from the first surface 820, the cylinder block 254 may rotate without resistance from a braking torque.

A force greater than the spring force of the second spring 336b, may push against the second piston 335b in a direction opposite to the spring force. The force may compress the second spring 336b supporting the second actuator 334b. If the pressure is greater than or equal to the threshold pressure, the force of pressure from work fluid is greater or equal than a threshold of force. When the force of pressure is greater than or equal to the threshold of force, the force may be greater than the spring force. When greater than or equal to the threshold of force, the force of the work fluid may act against the spring force, compressing the second spring 336b. The compression of the second spring 336b may decrease the first distance 828 to the second distance 872. Likewise, when the pressure is less than the threshold pressure, the force of pressure from the work fluid is less than the threshold of force. When the force of pressure is less than the threshold of force, the force of the spring force may act against the force of the work fluid. The second spring 336b may decompress, driving the second actuator 334b such that the second distance 872 may increase to the first distance 828.

It is to be appreciated that the aforementioned components and features of the second hole 330b, second chamber 332b, second actuator 334b, and fifth bearing assembly 522b described and shown with respect to FIGS. 8A-8B, may be present with approximately the same dimensions and mirrored for the first hole 330a, first chamber 332a, first actuator 334a, and fourth bearing assembly 522a of FIG. 5. Likewise, the components and features mirrored for the first hole 330a, first chamber 332a, first actuator 334a, and fourth bearing assembly 522a, may function as the components and features of second hole 330b, second chamber 332b, second actuator 334b, and fifth bearing assembly 522b as described above with respect to FIG. 8A-8B.

Referring now to FIG. 9, a plurality of timing diagrams 900, specifically for operating a sequence of the brake system for a hydraulic motor, is shown. The brake system is of a drum brake configuration, such as the brake assembly 314 of FIGS. 3A-3B. The operation sequence may include the brake state of the brake system and the application of braking torque applied to the rotational elements of a hydraulic motor. The operating sequence of FIG. 9 may be provided via the system of FIGS. 1-8B. The vertical lines at times t0-t8 represent times of interest during the operating sequence. The plots are time aligned. The horizontal axis of each plot represents time and time increases from the left side of the plot to the right side of each plot.

The first plot from the top of FIG. 9 is a plot of command signals to brake system of a hydraulic motor assembly of the present disclosure versus time. There are two commands available for the brake system: open and closed. The vertical axis represents the command to the braking system. A trace 902 may represent a signal, such as a command signal, to open or close the brake over time. When a trace 902 is at or above the tick labeled close on the vertical axis, the brake is signaled to enter or remain in a closed state. When the trace 902 is at or below the tick labeled open on the vertical axis, the brake is signaled to enter or remain in an open state. The command signal may be changed via user input (e.g., an operator input). User input send a brake command may be input via a braking input devices, such as a brake pedal or another brake input device of input devices 114 of FIG. 1. The command signal to open or close the brake may adjust the torque applied by the braking system, position of actuator, pressure, and state of the brake system.

The second plot from the top of FIG. 9 is a plot of torque applied by the braking system to a rotary group, such as rotary group 214 of FIG. 2, of the hydraulic motor verses time. The torque (e.g., braking torque) applied to the rotary group of the hydraulic motor may be applied via the brake pads of a plier assembly to a block, such as a cylinder block 254 of FIG. 2. The vertical axis represents the torque applied to the rotary group. The trace 904 represents the maintenance of the load when pressure to the first piston 335a and the second piston 335b is removed thereby bringing the pistons in contact with the first plier 434 and the second plier 436, respectively, and the first plier 434 and the second plier 436 in contact with the cylinder block 254. The push of the springs 336a and 336b is such as to have a linear trend in the maintenance of the load. This is seen when the torque rises and remains so in time until the first piston 335a and the second piston 335b are unlocked through the pressure, removing the first plier 434 and the second plier 436 from contact with the cylinder block 254.

The third plot from the top of FIG. 9 is a plot displacement of an actuator from a position when the springs are fully compressed versus time. When the springs are fully compressed, the braking system may be in a fully opened state. As the pressure decreases, the displacement may increase. As the displacement increases, the actuator slide in a direction closer to the surface of a structure that supports brake pads or brake shoes. The vertical axis represents the distance of displacement. The trace 906 represents displacement over time.

The fourth plot from the top of FIG. 9 is a plot of pressure from work fluid against the actuator versus time. As the pressure decreases, there is less of a force to counter the spring force of springs complementary to the actuator. The spring force may then actuate the actuator causing the displacement to increase as shown in trace 906. The vertical axis represents the pressure of work fluid in a chamber housing the actuator. The trace 908 represents the pressure over time.

The fifth plot from the top of FIG. 9 is a plot of the states of the brake system of a hydraulic motor assembly of the present disclosure versus time. There are four states available to the brake system: the fully open state, an open state, a partially closed state, and a closed state. The closed state may be when the brake is fully closed. When the brake is fully closed, the diameter of a brake structure, such as plier assembly 252 of FIG. 2, does not decrease further for the brake command. A trace 910 may represent the state of brake system at various periods of time. The states of the brake are dependent on the position of the actuator. The position of the actuator may be represented by the displacement shown the third graph from the top and trace 906. The brake system may be at the fully opened state when the pressure is at a maximum and the actuator is at an approximate position that is a predetermined distance from a structure. For example, the position may be the second position of actuator 334b shown in eighth view 850 of FIG. 8B. The predetermined distance at approximately zero units of distance for the displacement as shown by trace 906. The structure is an assembly, such as the plier assembly 252, that is of a drum brake configuration and has components supporting brake pads or brake shoes. The brake system may be open when the actuator is not in surface sharing contact and applying a spring force to a surface the structure.

The brake system may be partially closed in trace 910 when the actuator makes surface sharing contact with a surface of the structure supporting brake pads or brake shoes. The brake pads or brake shoes may have a high friction inner surface, such as the first inner surface 722a and the second inner surface 722b shown in FIG. 7. When the brake system is partially closed, the structure may begin compression. When starting compression, a brake torque may be applied via surface sharing contact between the high friction inner surface and a complementary high friction surface of the rotary assembly, such as surface 624 of FIG. 6. The brake torque may increase in the partially closed phase as the area in surface sharing contact between the high friction inner surface and high friction surface of the rotary assembly increases. The brake system may be fully closed in trace 910 when the area in surface sharing contact between the high friction inner surface and the complementary high friction surface remains constant for a set period of time. The brake system may be fully closed when the structure is at a minimum diameter about a rotary group, such as rotary group 214. When fully closed, an approximately constant brake torque is applied by the brake system to the rotary group.

At time t0, the brake is in an open state wherein work fluid may be pressurized such that actuators of the brake system do not apply force to the brake pads and the brake pads are not applying a braking torque via frictional force to the rotary group. Approximately no torque is applied to rotational elements of hydraulic motor from the braking system. At time t0, the braking system is open such that the trace 902 is in the open position. At time t0, the braking system does not apply torque to the rotary group. At time to, the trace 904 shows the torque applied to the rotary group from the braking system is approximately 0 units. At t0, the trace 906 shows the actuator is displaced from a start position at approximately 0 units. At t0, the trace 908 shows the pressure is at a maximum such that the spring or springs complementary to the actuator are fully compressed. For this example, at t0, the brake system is in a fully open state as shown by trace 910.

At t1, the brake system starts to transition from an open position to a closed position. Trace 902 shows the braking system is commanded to switch from the open position to the closed position. At time t1, the pressure to the braking system decreases, as shown in trace 908, with the command to switch to the closed position. As the pressure decrease, less force may act on the actuator against the spring force of the complementary spring. At time t1 the spring may slide the actuator and the displacement may begin to increase. At t1, trace 910 shows the brake system transitions from the fully open to open state. At t1, the torque applied from the braking system remains zero as shown by trace 904. Between t1 and t2, trace 908 and trace 906 shows that as the pressure decreases, the displacement may increase. Between t1 and t2, the displacement is shown to increase in parabolic pattern via trace 906. Between t1 and t2, the pressure is shown to decrease in a parabolic pattern. Between t1 and t2, trace 904 shows that the torque from the braking system remains approximately constant at zero.

At t2 the actuator makes contact with the structure. At t2 the structure may begin to compress and the brake system enters into a partially closed state as shown by trace 910. Portions of the inner surface of the structure that have a high friction, may begin to abut a high friction surface of the rotary group. The friction of the structure applies a brake torque, as shown by trace 904. Between t2 and t3, trace 908 shows the pressure continues to decrease and trace 906 shows the displacement continues to increase. Between t2 and t3, the rate of displacement may begin to decrease, as shown by trace 906, as the structure provides resistance when compressed by the actuator. Between t2 and t3, trace 904 shows the torque continues to increase.

At t3, the components of brake system fully transition to a closed position as shown by trace 910. At t3, trace 904 shows the torque applied stops increasing and plateaus. Between t3 and t6, trace 904 shows an approximately constant torque is applied by the braking system to the rotary group. Likewise, at t3, trace 906 the displacement stops increasing and plateaus. Between t3 and t6, trace 906 shows the displacement remains constant. The time between t3 and t6 may be referred to as a dynamic phase for the braking system. When in the dynamic phase, the braking system may be fully closed. Compared to a braking system that is not of a drum type configuration, the torque transmitted by the braking system is an approximately constant torque. For example, the range of torque may be approximately constant+/−3%. Such an approximately constant torque may minimize vibrations and other movements of the implement while braking.

Between t3 and t4, the pressure may continue to decrease as shown in the example of trace 908. The resistance from the structure of brake system may prevent movement of the actuator despite the pressure decrease and force from the spring, such as when the structure is compressed to a minimum diameter about the rotary group. At t4, trace 908 shows the pressure may stop decreasing. Between t4 and t5, the pressure may remain approximately constant as shown in trace 908. However, for another example, such as when the structure is not fully compressed, the pressure may stop decreasing at t3. For this example, the pressure may remain constant between t3 and t5, wherein the time between t3 and t4 is infinitesimally small.

At t5, the brake system starts transitioning from a closed position to an open position. Trace 902 shows the braking system is commanded to switch from the closed position to open position. At time t5, the pressure to the braking system begins increasing. Between t5 and t8, trace 908 shows the pressure increasing in a parabolic fashion. However, between t5 and t6 the pressure is not great enough to overcome the spring force. Between t5 and t6, traces 904, 906, and 910 show the torque, displacement, and state, respectively, of the braking system remain constant.

At t6 the force of pressure may be great enough to overcome the spring force placed on the actuator. At t6, trace 910 shows the brake system enters into the partially closed state. At 16, trace 906 shows the displacement may start to decrease with the increasing pressure shown in trace 908. Between t6 and t7, the displacement may decrease as the spring compresses. As the displacement decreases the actuator slides further from the structure and closer to the starting position at t0. With the decrease in displacement, the transfer of spring force to the structure may decrease and the diameter of the structure may increase. Between t6 and t7, trace 904 shows the torque is reduced as diameter of the structure increases. Between t6 and t7, trace 904 shows that the torque from the braking system to the rotary decreases in a more proportionally linear fashion.

However, for another example, such as when the structure is not fully compressed, the displacement may start decreasing at t5. For this example, the displacement may decrease between t5 and t7, wherein the time between t5 and t6 is infinitesimally small.

At t7 the actuator may be out of surface sharing contact with the structure, and therein the inner surfaces of the structure may not be in surface sharing contact with the rotary group. At t7, the trace 904 shows the torque applied by the brake system to the rotary group reduces to approximately 0 units of torque. Between t7 and t8 trace 904 shows the torque may remain approximately constant at 0 units of torque.

Returning to the example, between t7 and 18 the trace 906 shows the displacement continues to decrease. Between t7 and t8, the trace 908 pressure continues to increase 908. At t8 the trace 906 shows the pressure stops increase. At t8 the pressure returns to approximately the starting pressure at t0. The return to the starting pressure at to compresses the spring of the actuator to their original position at t0. The trace 906 shows the displacement at t8 is approximately the same position as the displacement at t0. At t8, the trace 910 shows the brake system enters a fully opened state. After t8, the trace 908 shows the pressure remains approximately constant. Without an increase or decrease in pressure, the trace 906 shows the displacement remains approximately constant. After 18, the trace 910 shows brake system remains in the fully opened state.

It is to be appreciated that at to the hydraulic motor is operating and the hydraulic motor and braking system are pressurized with work-fluid. For an example, the hydraulic motor may not be receiving work fluid to rotate and the hydraulic motor braking system may not be pressurized, such as when the hydraulic motor is off. When not pressurized, the braking system is commanded to be in a closed state, similar to when a close state is commanded to be in closed state. For this example, the brake system may be at or transitioned to a closed state, such as in trace 910 between t4 and t6. If the rotary group is still rotating when the brake system is transitioned to a closed state, a constant torque, such as the torque between t3 and t6 of trace 904, may be applied until the rotary group is at rest. The trace 906 is at greater displacement, such as at the displacement between t3 and t6. The pressure of the braking system is at a low pressure, such as at atmosphere or a minimum pressure, such as the pressure between t4 and t5 of trace 908.

In this way, a braking system may be open or closed, to apply or remove a torque from the braking system to the rotary group of a hydraulic motor. The reduction pressure of work fluid to the braking system may allow the brake to close. The increase in pressure of work fluid to the braking system may allow the brake to open. When the brake is placed in a closed state and the brake is fully engaged to a requested torque, the torque transmitted by the braking system may be approximately constant. The drum brake configuration of the brake assembly, including the plier assembly comprised of brake pads or brake shoes and the high friction surface of the cylinder block, may allow a more constant brake torque compared to other types of brake assemblies for a hydraulic motor.

In another representation, an actuator system for a hydraulic axial piston motor comprising: a motor housing in fluid communication with a hydraulic block, the motor housing comprising a first chamber and a second chamber, the second chamber opposing the first chamber with respect to a rotational axis of the hydraulic axial piston motor; a first actuator positioned in the first chamber; a second actuator positioned in the second chamber; a cylinder block positioned inside the motor housing; and a pair of braking pads positioned around the cylinder block, wherein a flow of fluid from the hydraulic block to the first chamber and the second chamber selectively controls compression of the first actuator and the second actuator against the pair of braking pads thereby controlling rotation of the cylinder block.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle and/or transmission control system, where the described actions are carried out by executing the instructions in a system including the various hardware components in combination with the electronic controller. One or more of the method steps described herein may be omitted if desired.

It will be appreciated that the configurations and routines disclosed herein are exemplary in nature, and that these specific embodiments are not to be considered in a limiting sense, because numerous variations are possible. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

FIGS. 2-8B show example configurations with relative positioning of various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The invention claimed is:

1. A brake assembly for a hydraulic axial piston motor, comprising: a cylinder block and a pair of braking pads positioned around the cylinder block, wherein compression of the braking pads against an outer surface of the cylinder block realizes braking of the cylinder block.

2. The brake assembly of claim 1, wherein the compression is hydraulically actuated.

3. The brake assembly of claim 1, wherein the outer surface of the cylinder block is a high-friction outer surface.

4. The brake assembly of claim 1, wherein the pair of braking pads are arched braking pads joined together by a pin and having a common pivot point.

5. The brake assembly of claim 1, wherein each braking pad comprises a high-friction inner surface.

6. The brake assembly of claim 1, further comprising an actuator system comprising a first piston supported by a first spring, a second piston supported by a second spring, wherein the actuator system selectively controls the compression of the pair of braking pads based on hydraulic pressure exerted on the first piston and the second piston.

7. The brake assembly of claim 6, wherein the first piston and the second piston are arranged perpendicular to an axis of rotation of the cylinder block.

8. The brake assembly of claim 1, wherein the outer surface of the cylinder block is an interference bushing with a bearing.

9. The brake assembly of claim 1, wherein a direction of the compression is perpendicular to an axis of rotation of the cylinder block.

10. A hydraulic motor assembly comprising:
a housing;
a hydraulic piston assembly positioned in the housing, the hydraulic piston assembly comprising a cylinder block;
a pair of braking pads positioned around the cylinder block;
an actuator system coupled to the pair of braking pads; and
a hydraulic block fluidly coupled to the hydraulic piston assembly and the actuator system;
wherein a flow of fluid from the hydraulic block to the actuator system selectively controls a compression of the pair of braking pads on the cylinder block.

11. The hydraulic motor assembly of claim 10, the actuator system further comprising a first piston supported by a first spring and a second piston supported by a second spring, wherein the actuator system selectively controls the compression of the pair of braking pads based on hydraulic pressure exerted on the first piston and the second piston.

12. The hydraulic motor assembly of claim 11, the housing further comprising a first chamber and a second chamber, wherein the first piston and first spring are positioned within the first chamber and the second piston and the second spring are positioned within the second chamber.

13. The hydraulic motor assembly of claim 10, wherein the cylinder block comprises a high-friction outer surface.

14. The hydraulic motor assembly of claim 10, wherein the pair of braking pads are arched braking pads joined together by a pin and having a common pivot point, wherein each braking pad comprises a high-friction inner surface.

15. (canceled)

16. A method of operating a brake assembly for a hydraulic axial piston motor, the brake assembly comprising a cylinder block and a pair of braking pads positioned around the cylinder block, the method comprising:
receiving a user input;
adjusting a flow of hydraulic fluid through the hydraulic axial piston motor based on the user input; and
in response to less than a threshold pressure:
decompressing a first spring supporting a first piston and a second spring supporting a second piston;
compressing the pair of braking pads against the cylinder block; and
reducing rotation of the cylinder block; and
in response to greater than threshold pressure:
compressing the first spring supporting the first piston and the second spring supporting the second piston;
releasing the pair of braking pads from compression against the cylinder block; and
increasing rotation of the cylinder block.

17. The method of claim 16, wherein the threshold pressure is greater than a spring force of the first spring and the second spring, wherein the cylinder block comprises a high-friction outer surface, and wherein the pair of braking pads comprise a high-friction inner surface.

18. The method of claim 16, wherein the compressing decreases a radial distance between an inner surface of the pair of braking pads and a central axis of the cylinder block and wherein the decompressing increases the radial distance between the inner surface of the pair of braking pads and the central axis of the cylinder block.

19-20. (canceled)

21. The brake assembly of claim 1, further comprising a controller including a processor and a memory, the memory holding instructions therein that when executed by the processor cause the controller to:
receive a user input; and
adjust a pressure of work fluid through the brake assembly based on the user input,
wherein the brake assembly further comprises an actuator system comprising a first piston supported by a first spring and a second piston supported by a second spring, wherein the pressure of the work fluid to the actuator system selectively controls the compression of the pair of braking pads on the cylinder block,
where in response to the pressure of the work fluid exceeding a threshold pressure, the first spring supporting the first piston and the second spring supporting the second piston are configured to compress, releasing the pair of braking pads from compression against the cylinder block, and increasing rotation of the cylinder block, and
where in response to the pressure of the work fluid at or below the threshold pressure, the first spring supporting the first piston and the second spring supporting the second piston are configured to decompress, compressing the pair of braking pads against the cylinder block, and reducing rotation of the cylinder block.

22. The brake assembly of claim 21, where in response to the pressure of the work fluid exceeding the threshold pressure, a radial distance between an inner surface of the pair of braking pads and a central axis of the cylinder block is configured to decrease, and where in response in response to the pressure of the work fluid at or below the threshold pressure, the radial distance between the inner surface of the pair of braking pads and the central axis of the cylinder block is configured to increase.

23. The brake assembly of claim 21, wherein the threshold pressure is greater than a spring force of the first spring and the second spring.
